(19) United States
(12) Patent Application Publication
(10) Pub. No.: US 2017/0060238 A1
(43) Pub. Date: Mar. 2, 2017

(54) WARNING APPARATUS FOR COMPUTER

(71) Applicant: Primax Electronics Ltd., Neihu (TW)

(72) Inventors: YING-CHE TSENG, Neihu (TW); CHENG-YI TSAI, Neihu (TW)

(21) Appl. No.: 14/923,142

(22) Filed: Oct. 26, 2015

(30) Foreign Application Priority Data
Aug. 28, 2015 (TW) 104128439

(51) Int. Cl. G06F 3/01; G06F 1/16; G06F 3/0354; G06F 3/02; G06F 3/03

(52) U.S. Cl. CPC G06F 3/016; G06F 3/02; G06F 3/0227; G06F 3/0304; G06F 3/03543; G06F 1/163

(57) ABSTRACT

A warning apparatus for a computer comprises an input device and a wearable device. The wearable device is in wireless connection with the input device. The input device includes a sensor and a first microprocessor. The wearable device includes a body stimulating device. In case that the sensor detects the hand of the user, the sensor generates a sensing signal to the first microprocessor. If the time length that the first microprocessor continuously receives the sensing signal reaches a predetermined time value, the first microprocessor generates a driving signal. In response to the driving signal, the body stimulating device generates a body stimulation signal to stimulate the user. Consequently, a warning function is achieved.

### FIELD OF THE INVENTION

The present invention relates to a warning apparatus, and more particularly to a warning apparatus for a computer.

### BACKGROUND OF THE INVENTION

As known, computers are indispensable to modern daily lives of people. Whenever people work, learn something new, go shipping, entertain themselves or communicate with each other, the software components and the hardware components of the computers are required. Consequently, computers bring fast and convenient lives to people. Generally, people (especially office workers, engineers, researchers or students) spend a lot of time sitting in front of the computers every day. However, sitting in front of the computer for a long time easily lead to fatigue and physical decline, and even causes various abnormalities or diseases in eyes, brain, nerves, joints or endocrine. For solving the above drawbacks, the user has to leave the computer timely to allow the body to rest or walk.

When people use computers, they often ignore time unconsciously. If they concentrate their attention on work studies or computer games, it is more difficult for the users to suspend the computers voluntarily. For solving the above drawbacks, a warning device is usually installed in the conventional computer for detecting the use condition of the computer. If the computer has been used for a certain time period, the warning device will issue a warning message.

However, the conventional warning device still has some drawbacks. For example, the installation of the warning device may increase the overall volume of the computer. Moreover, since the location of installing the warning device is limited, the warning device is unable to precisely detect the use condition of the computer. Moreover, the issued warning message is easily ignored by the user. In other words, the conventional technologies need to be further improved.

### SUMMARY OF THE INVENTION

For solving the drawbacks of the conventional technologies, the present invention provides a warning apparatus for a computer. A wearable device with a body stimulating device is worn on a hand of a user. Consequently, the function of warning the user is effectively achieved.

In accordance with an aspect of the present invention, there is provided a warning apparatus for a computer. The warning apparatus includes an input device and a wearable device. The input device includes a sensor and a first microprocessor. When an object over the input device is detected by the sensor, the sensor generates a sensing signal. After the first microprocessor receives the sensing signal, the first microprocessor counts a time length of continuously receiving the sensing signal. When the time length of continuously receiving the sensing signal reaches a predetermined time value, the first microprocessor generates a driving signal. The wearable device is contacted with a user and wirelessly connected with the input device. The wearable device includes a body stimulating device and a second microprocessor. The body stimulating device is disposed within the wearable device and contacted with the user. The second microprocessor is connected with the body stimulating device. When the second microprocessor wirelessly receives the driving signal, the second microprocessor drives the body stimulating device to generate a body stimulation signal, and the body stimulation signal is transmitted to the user to warn the user.

In an embodiment, the object is a hand of the user. When the hand is continuously placed over the input device, the sensor continuously generates the sensing signal.

In an embodiment, when the hand is continuously placed over the input device, an ambient light beam is obstructed from being transmitted to the sensor, so that the sensor continuously generates the sensing signal.

In an embodiment, the input device further includes a sensing light source. When the hand is continuously placed over the input device, a sensing beam from the sensing light source is reflected by the hand, and the reflected sensing beam is received the sensor, so that the sensor continuously generates the sensing signal.

In an embodiment, if the time length of continuously receiving the sensing signal by the first microprocessor does not reach the predetermined time value, the first microprocessor stops counting the time length. Moreover, the first microprocessor re-counts the time length after the sensing signal is received again.

In an embodiment, the second microprocessor detects a signal strength of a wireless connection signal. If the signal strength of the wireless connection signal is lower than a threshold value, the second microprocessor generates a disabling signal to the body stimulating device. In response to the disabling signal, the body stimulating device stops generating the body stimulation signal.

In an embodiment, the warning apparatus further includes a predetermined time setting program. Through the predetermined time setting program, the user sets the predetermined time value and transmits the predetermined time value to the first microprocessor.

In an embodiment, the predetermined time value is stored in the first microprocessor.

In an embodiment, the warning apparatus further includes a stimulation intensity adjusting program. The stimulation intensity adjusting program is installed in a handheld device. Through the stimulation intensity adjusting program, the user set an adjusting value and transmits the adjusting value to the second microprocessor.

In an embodiment, the adjusting value is further transmitted from the second microprocessor to the body stimulating device, and the body stimulating device adjusts an intensity of the body stimulation signal according to the adjusting value.

In an embodiment, the input device further comprises an alarm. After the alarm receives the driving signal, the alarm generates a warning signal.

In an embodiment, the input device is a keyboard, and the keyboard includes at least one light-transmissible key. The sensor is disposed under the at least one light-transmissible key.

In an embodiment, the input device is a mouse, and the keyboard includes a light-transmissible part. The sensor is disposed under the light-transmissible part.

In an embodiment, the sensor is an optical sensor.

In an embodiment, the body stimulating device is a micro electric shock device.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the use condition of a time-counting warning apparatus for a computer according to an embodiment of the present invention;

FIG. 2 is a schematic exploded view illustrating an exemplary input device (keyboard) of the warning apparatus according to the embodiment of the present invention;

FIG. 3 is a schematic exploded view illustrating another exemplary input device (mouse) of the warning apparatus according to the embodiment of the present invention;

FIG. 4 is a schematic exploded view illustrating the wearable device of the warning apparatus according to the embodiment of the present invention;

FIG. 5 is a schematic exploded view illustrating an exemplary input device (keyboard) of the warning apparatus according to another embodiment of the present invention;

FIG. 6 is a schematic functional block diagram of the warning apparatus according to an embodiment of the present invention; and

FIG. 7 schematically illustrates the use of a handheld device to set associated parameters of the warning apparatus.

### DETAILED DESCRIPTION OF THE PREFERRED EMBODIMENT

The present invention will now be described more specifically with reference to the following embodiments and accompanying drawings.

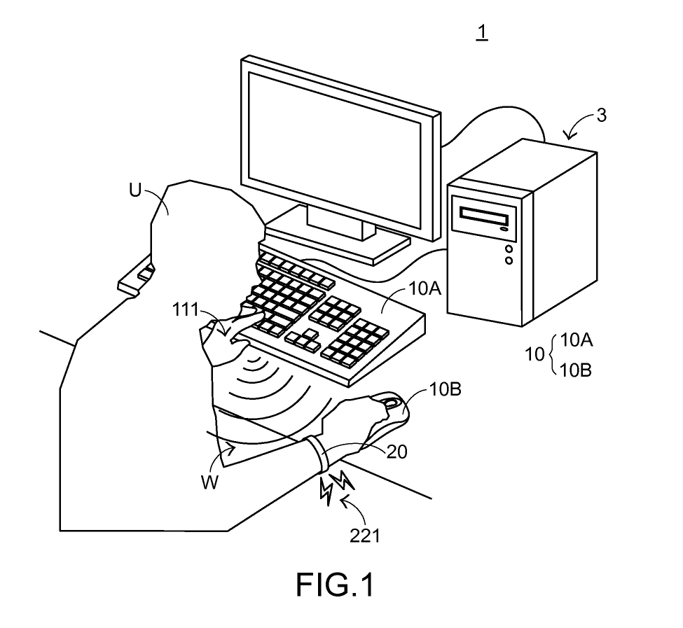

The use condition of a warning apparatus of the present invention will be illustrated with reference to FIG. 1. FIG. 1 schematically illustrates the use condition of a time-counting warning apparatus for a computer according to an embodiment of the present invention.

As shown in FIG. 1, the warning apparatus 1 is applied to a computer 3. That is, the warning apparatus 1 is used with the computer 3. In this embodiment, the warning apparatus 1 comprises an input device 10 and a wearable device 20. The input device 10 and the wearable device 20 are in wireless connection with each other through a wireless connection signal in a range of a signal strength W.

While the user U uses the computer 3, the wearable device 20 is worn on a wrist of the user U. After the input device 10 is operated by the user U, the input device 10 detects an object over the input device 10. For example, the object is a hand 111 of the user U that is placed over the input device 10. Consequently, the input device 10 starts to count the time length that the hand 111 of the user U that is placed over the input device 10. If the time length reaches a predetermined time value, the input device 10 notifies the wearable device 20. When the wearable device 20 receives the notification from the input device 10, the wearable device 20 generates a body stimulation signal 221. In response to the body stimulation signal 221, the body of the user U can directly feel the stimulation. Consequently, the user U will not unconsciously ignore the warning message about the prolong use of the computer 3.

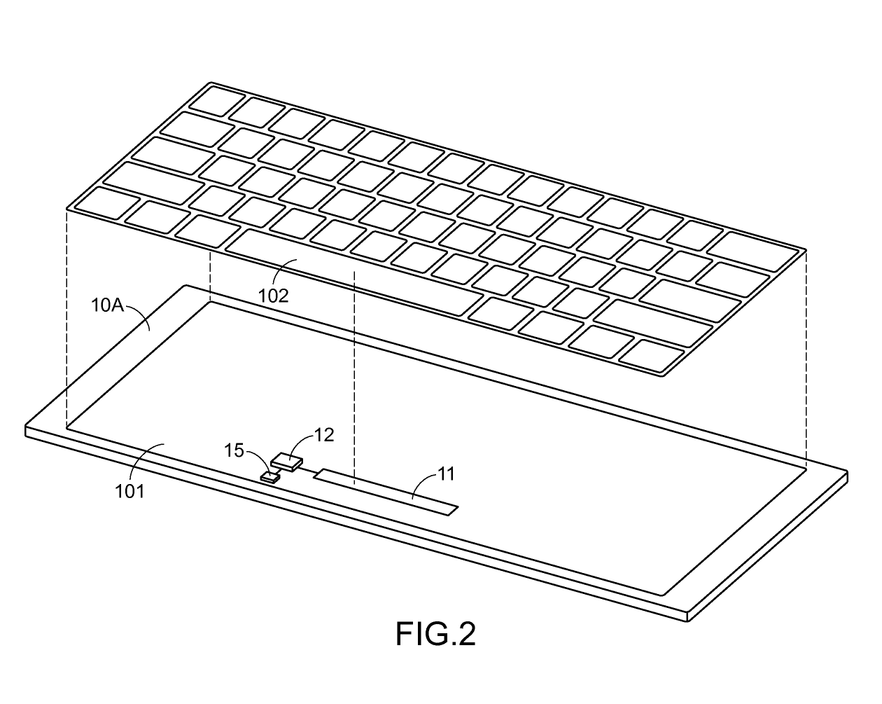

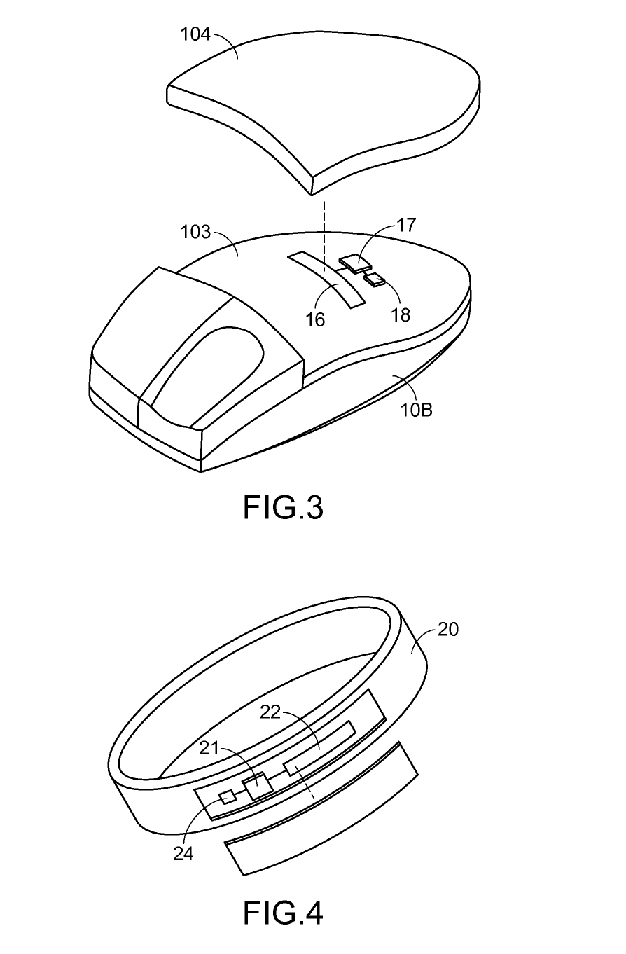

The architecture of the warning apparatus 1 will be illustrated in more details with reference to FIGS. 2, 3 and 4. FIG. 2 is a schematic exploded view illustrating an exemplary input device (keyboard) of the warning apparatus according to the embodiment of the present invention. FIG. 3 is a schematic exploded view illustrating another exemplary input device (mouse) of the warning apparatus according to the embodiment of the present invention. FIG. 4 is a schematic exploded view illustrating the wearable device of the warning apparatus according to the embodiment of the present invention.

As shown in FIG. 2, the input device 10 is a keyboard 10A. The keyboard 10A comprises a circuit board 101 and at least one light-transmissible key 102. The light-transmissible key 102 is made of a light-transmissible material. Moreover, the light-transmissible key 102 is the widely-used key of the keyboard. For example, the at least one light-transmissible key 102 includes a space key, an Enter key, a numeric key, and so on. The circuit board 101 is disposed under the at least one light-transmissible key 102. The keyboard 10A further comprises a first microprocessor 12, an alarm 15 and a sensor 11. The first microprocessor 12, the alarm 15 and the sensor 11 are disposed on the circuit board 101. The alarm 15 is connected with the first microprocessor 12. The sensor 11 is connected with the first microprocessor 12, and disposed under the at least one light-transmissible key 102. In an embodiment, the sensor 11 is an optical sensor.

As shown in FIG. 3, the input device 10 is a mouse 10B. The mouse 10B comprises a circuit board 103 and a light-transmissible part 104. The light-transmissible part 104 is made of a light-transmissible material. The circuit board 103 is disposed under the light-transmissible part 104. The mouse 10B further comprises a first microprocessor 17, an alarm 18 and a sensor 16. The first microprocessor 17, the alarm 18 and the sensor 16 are disposed on the circuit board 103. The alarm 18 is connected with the first microprocessor 17. The sensor 16 is connected with the first microprocessor 17, and disposed under the light-transmissible part 104. In an embodiment, the sensor 16 is an optical sensor.

The structure of the wearable device 20 is shown in FIG. 4. The wearable device 20 comprises a second microprocessor 21, a body stimulating device 22 and a boost circuit 24. For example, the body stimulating device 22 is a micro electric shock device. The wearable device 20 is wireless connection with the input device 10. Moreover, a wireless connection signal to be transmitted between the wearable device 20 and the input device 10 is maintained in a range of a specified signal strength W. The body stimulating device 22 is disposed on a surface of the wearable device 20, and connected with the second microprocessor 21. The boost circuit 24 is connected with the second microprocessor 21. The boost circuit 24 is used for stabilizing or increasing the voltage that is required for the second microprocessor 21 and the body stimulating device 22.

The operations of the warning apparatus 1 will be described as follows. In particular, the operations of the warning apparatus 1 with the keyboard 10A and the wearable device 20 will be illustrated as follows.

First of all, the process of detecting the user's hand 111 through the keyboard 10A will be described. The sensor 11 within the keyboard 10A can sense the ambient light beam. When the user U operates the input device 10, the hand 111 of the user U may be placed over the light-transmissible key 102. Since the ambient light beam is obstructed by the hand 111, the sensor 11 cannot sense the ambient light beam or the sensor 11 can sense a weak light beam. Under this circumstance, the sensor 11 generates a sensing signal 112. In case that the hand 111 is continuously placed over the keyboard 10A, the sensing signal 112 is continuously generated.

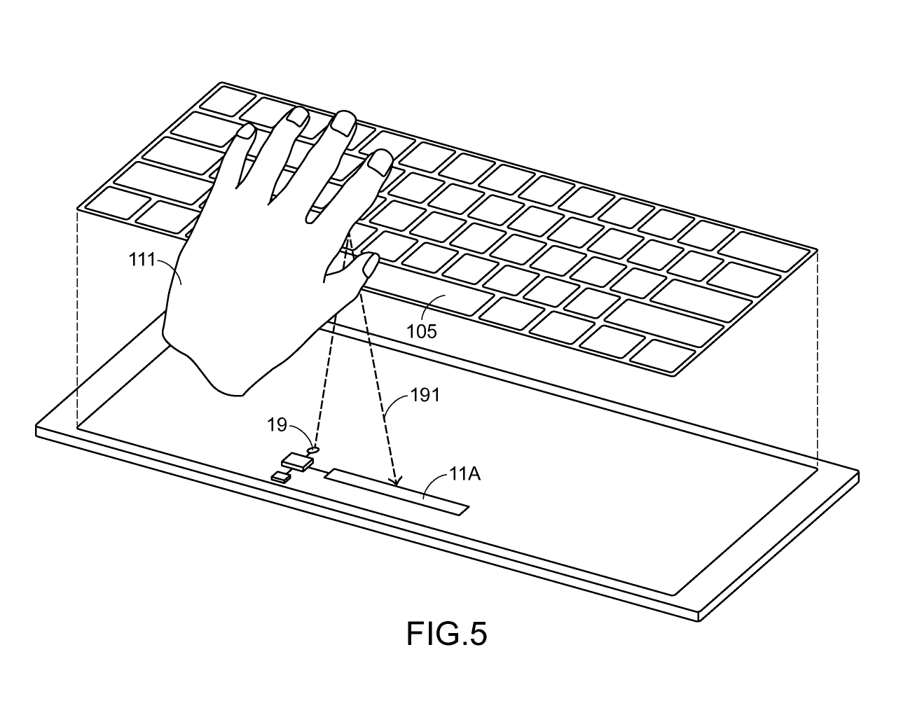

Another process of detecting the user's hand 111 will be described will reference to FIG. 5. FIG. 5 is a schematic exploded view illustrating an exemplary input device (keyboard) of the warning apparatus according to another embodiment of the present invention. In this embodiment, the keyboard 10A further comprises a sensing light source 19. The sensing light source 19 is disposed under at least one light-transmissible key 105. The sensing light source 19 continuously emits a sensing beam 191. The sensing beam 191 passes through the at least one light-transmissible key 105. When the hand 111 is placed over the at least one light-transmissible key 105, the sensing beam 191 is reflected by the hand 111. When the reflected sensing beam 191 is projected on a sensor 11A, the reflected sensing beam 191 is received by the sensor 11A. Consequently, the sensor 11A generates a sensing signal.

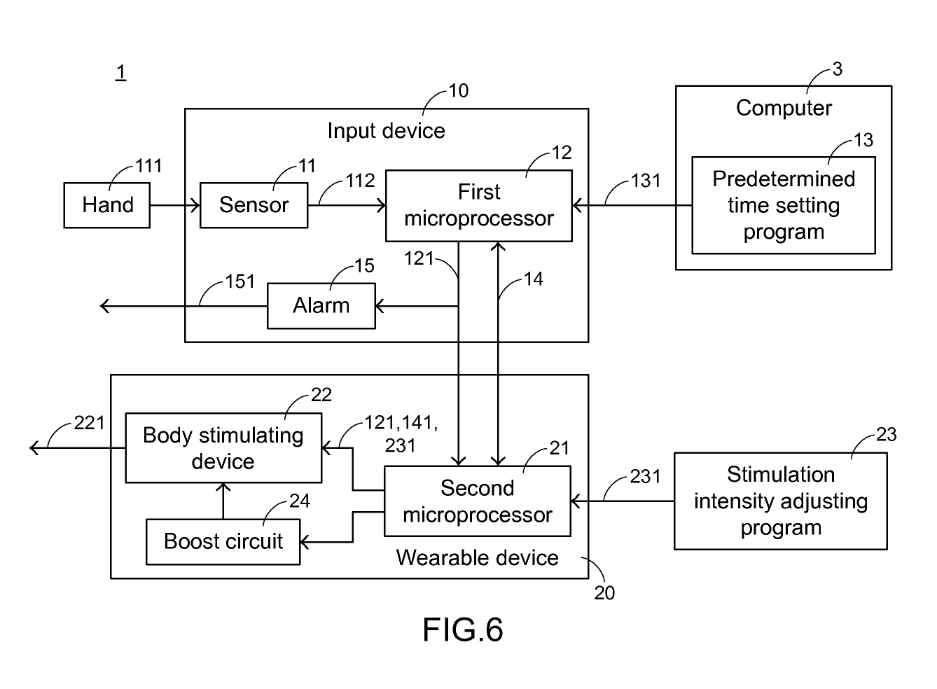

The subsequent process will be described as follows. Please refer to FIG. 6, which is a schematic functional block diagram of the warning apparatus according to an embodiment of the present invention. Then, the sensing signal 112 is transmitted from the sensor 11 to the first microprocessor 12. The first microprocessor 12 has a predetermined time value 131. After the first microprocessor 12 receives the sensing signal 112, the first microprocessor 12 starts to count the time length of continuously receiving the sensing signal 112 and compares the time length with the predetermined time value 131. If the time length of continuously receiving the sensing signal 112 reaches the predetermined time value 131, the first microprocessor 12 generates a driving signal. The driving signal 121 is transmitted to the alarm 15 and wirelessly transmitted to the second microprocessor 21. After the alarm 15 receives the driving signal 121, the alarm 15 generates a warning signal 151. For example, the warning signal 151 includes a buzz sound or a warning light. After the second microprocessor 21 receives the driving signal 121, the driving signal 121 is further transmitted from the second microprocessor 21 to the body stimulating device 22. In response to the driving signal, the body stimulating device 22 generates a body stimulation signal 221 to stimulate the skin of the user U. Consequently, the warning function is achieved. If the hand 111 of the user U operates the input device 10 for a short time, the time length that the first microprocessor 12 continuously receives the sensing signal 112 does not reach the predetermined time value 131. Under this circumstance, the first microprocessor 12 stops counting the time length, and the first microprocessor re-counts the time length after the sensing signal 112 is received again.

Moreover, the second microprocessor 21 and the first microprocessor 12 are in wireless connection with each other through a wireless connection signal 14. The wireless connection signal 14 is maintained in a range of a specified signal strength W. In an embodiment, the signal strength W is −100 dBm. The term “dBm” is a unit of a received signal strength indication (RSSI) value. Generally, dBm has a negative value. In case that the negative value of dBm is close to zero, the RSSI is better and usually used as an index of judging the distance. Generally, once the user U is stimulated and warned by the body stimulation signal 221, the user U may leave the input device 10. Under this circumstance, the second microprocessor 21 detects the signal strength W of the wireless connection signal 14. If the signal strength W excesses −100 dBm, it means that the user U leaves the input device 10 to take a rest and thus the RSSI value is very weak. Meanwhile, the second microprocessor 21 generates a disabling signal 141 to the body stimulating device 22. In response to the disabling signal 141, the body stimulating device 22 stops generating the body stimulation signal 221. Moreover, since the user U leaves the input device 10, the alarm 15 of the input device 10 stops generating the buzz sound or the warning light. After the input device 10 receives the sensing signal 112 again, the first microprocessor will re-count the time length.

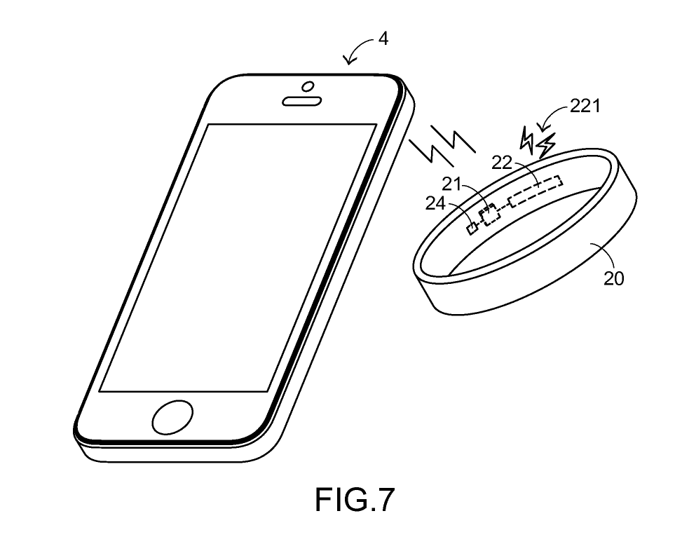

Moreover, the predetermined time value 131 is stored in the first microprocessor 12. In an embodiment, the predetermined time value 131 is previously defined in the first microprocessor 12 by the manufacturer while the input device 10 is fabricated. In a preferred embodiment, the predetermined time value 131 and the body stimulation signal 221 can be adjusted by the user. A process of adjusting the predetermined time value 131 and the body stimulation signal 221 will be illustrated with reference to FIGS. 6 and 7. FIG. 7 schematically illustrates the use of a handheld device to set associated parameters of the warning apparatus. As shown in FIG. 6, the warning apparatus 1 of the present invention further comprises a predetermined time setting program 13 and a stimulation intensity adjusting program 23. The predetermined time setting program 13 is installed in the computer 3 or a handheld device 4 (see FIG. 7). Through the predetermined time setting program 13, the user U can adjust the magnitude of the predetermined time value 131 in order to set the predetermined time value 131 according to the habit of the user. The stimulation intensity adjusting program 23 is installed in the computer 3 or the handheld device 4. Moreover, through the stimulation intensity adjusting program 23, the user U can adjust the intensity of the body stimulation signal 221. In particular, the user U can freely set an adjusting value 231 to the second microprocessor 21 through the stimulation intensity adjusting program 23. Consequently, the intensity of the body stimulation signal 221 that is suitable for the user is determined.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all modifications and similar structures.

What is claimed is:

1. A warning apparatus for a computer, the warning apparatus comprising:
an input device comprising a sensor and a first microprocessor, wherein when an object over the input device is detected by the sensor, the sensor generates a sensing signal, wherein after the first microprocessor receives the sensing signal, the first microprocessor counts a time length of continuously receiving the sensing signal, wherein when the time length of continuously receiving the sensing signal reaches a predetermined time value, the first microprocessor generates a driving signal; and
a wearable device contacted with a user and wirelessly connected with the input device, wherein the wearable device comprises a body stimulating device and a second microprocessor, wherein the body stimulating device is disposed within the wearable device and contacted with the user, and the second microprocessor is connected with the body stimulating device, wherein when the second microprocessor wirelessly receives the driving signal, the second microprocessor drives the body stimulating device to generate a body stimulation signal, and the body stimulation signal is transmitted to the user to warn the user.

2. The warning apparatus according to claim 1, wherein the object is a hand of the user, wherein when the hand is continuously placed over the input device, the sensor continuously generates the sensing signal.

3. The warning apparatus according to claim 2, wherein when the hand is continuously placed over the input device, an ambient light beam is obstructed from being transmitted to the sensor, so that the sensor continuously generates the sensing signal.

4. The warning apparatus according to claim 2, wherein the input device further comprises a sensing light source, wherein when the hand is continuously placed over the input device, a sensing beam from the sensing light source is reflected by the hand, and the reflected sensing beam is received the sensor, so that the sensor continuously generates the sensing signal.

5. The warning apparatus according to claim 1, wherein if the time length of continuously receiving the sensing signal by the first microprocessor does not reach the predetermined time value, the first microprocessor stops counting the time length, wherein the first microprocessor re-counts the time length after the sensing signal is received again.

6. The warning apparatus according to claim 1, wherein the second microprocessor detects a signal strength of a wireless connection signal, wherein if the signal strength of the wireless connection signal is lower than a threshold value, the second microprocessor generates a disabling signal to the body stimulating device, wherein the body stimulating device stops generating the body stimulation signal in response to the disabling signal.

7. The warning apparatus according to claim 1, further comprising a predetermined time setting program, wherein through the predetermined time setting program, the user sets the predetermined time value and transmits the predetermined time value to the first microprocessor.

8. The warning apparatus according to claim 1, wherein the predetermined time value is stored in the first microprocessor.

9. The warning apparatus according to claim 1, further comprising a stimulation intensity adjusting program, wherein the stimulation intensity adjusting program is installed in a handheld device, wherein through the stimulation intensity adjusting program, the user set an adjusting value and transmits the adjusting value to the second microprocessor.

10. The warning apparatus according to claim 9, wherein the adjusting value is further transmitted from the second microprocessor to the body stimulating device, and the body stimulating device adjusts an intensity of the body stimulation signal according to the adjusting value.

11. The warning apparatus according to claim 1, wherein the input device further comprises an alarm, wherein after the alarm receives the driving signal, the alarm generates a warning signal.

12. The warning apparatus according to claim 1, wherein the input device is a keyboard, and the keyboard comprises at least one light-transmissible key, wherein the sensor is disposed under the at least one light-transmissible key.

13. The warning apparatus according to claim 1, wherein the input device is a mouse, and the keyboard comprises a light-transmissible part, wherein the sensor is disposed under the light-transmissible part.

14. The warning apparatus according to claim 1, wherein the sensor is an optical sensor.

15. The warning apparatus according to claim 1, wherein the body stimulating device is a micro electric shock device.
